(19) United States
(12) Patent Application Publication
(10) Pub. No.: US 2009/0319504 A1
(43) Pub. Date: Dec. 24, 2009

(54) Method and Apparatus for Providing Enhanced Search Results to a User of a Communication Device

(75) Inventors: William P. Alberth, JR., Prairie Grove, IL (US); Steven F. Gillig, Roselle, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Schaumburg, IL (US)

(21) Appl. No.: 12/141,359

(22) Filed: Jun. 18, 2008

(51) Int. Cl. G06F 7/10; G06F 17/30

(52) U.S. Cl. 707/5; 707/E17.014

(57) ABSTRACT

A method and apparatus of a wireless communication system for providing enhanced search results to a user. The method includes monitoring data communication on a user device, determining at least one contextual datum from at least a portion of the monitored data based on a predetermined rule; and generating a search result by applying the determined contextual datum to a search application.

### FIELD OF THE DISCLOSURE

The present disclosure relates to a method and apparatus for providing enhanced search results to a user of a communication device.

### BACKGROUND

In this information era, information is readily available electronically, through information repositories. The Internet, the world's largest database, has made available enormous quantities of information to anyone with a personal computer and Internet access. This can be very helpful for people who wish to learn about something or conduct business in the convenience of their own homes.

Software applications commonly known as search engines are used to locate desired information available in the internet. To use a search engine, a user provides a set of words to search for, and the search engine returns a list of “hits,” or web sites containing those words. Search engines are advantageous in that they require little understanding of the operation of the search engine. However, they can be difficult to work with for a number of reasons. For example, existing search engines actually require the user to manually input some search query in the user interface in order to generate search results for the user. Especially, in a wireless communication environment, users who use portable devices may be constantly moving, and these users may not able to provide search input to the device in order to locate desired information. Existing search engines process only information that are provided by the user to generate search results, and do not take into account the real time data associated with the user for generating such results or have the capability to sense current search requirements of the user.

Accordingly, there is a need for a method for providing users with a convenient method, where a device itself can understand the search requirements of the user without the help of a user input and generate search results in the context of the current needs of the user.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system in accordance with some embodiments.

FIG. 2 is a block diagram illustrating an embodiment of an apparatus employed in the communication system of FIG. 1.

FIG. 3 is a flowchart illustrating a first method for providing enhanced search results to a user of a communication device in accordance with some embodiments.

FIG. 4 is a flowchart illustrating a second method for providing enhanced search results to a user of a communication device in accordance with some embodiments.

FIG. 5 is a flowchart illustrating a third method for providing enhanced search results to a user of a communication device in accordance with some embodiments.

FIG. 6 is a flowchart illustrating a fourth method for providing enhanced search results to a user of a communication device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a method and apparatus of a wireless communication system for providing enhanced search results to a user. The method includes monitoring data communication on a user device, determining at least one contextual datum from at least a portion of the monitored data based on a predetermined rule; and generating a search result by applying the determined contextual datum to a search application. The contextual datum may be a word, phrase, symbol, or picture communicated between the user's device and another device, and selected using predetermined rules. An example of a predetermined rule includes comparing the communication with a list. The list may include keywords or terms that would assist in limiting a search.

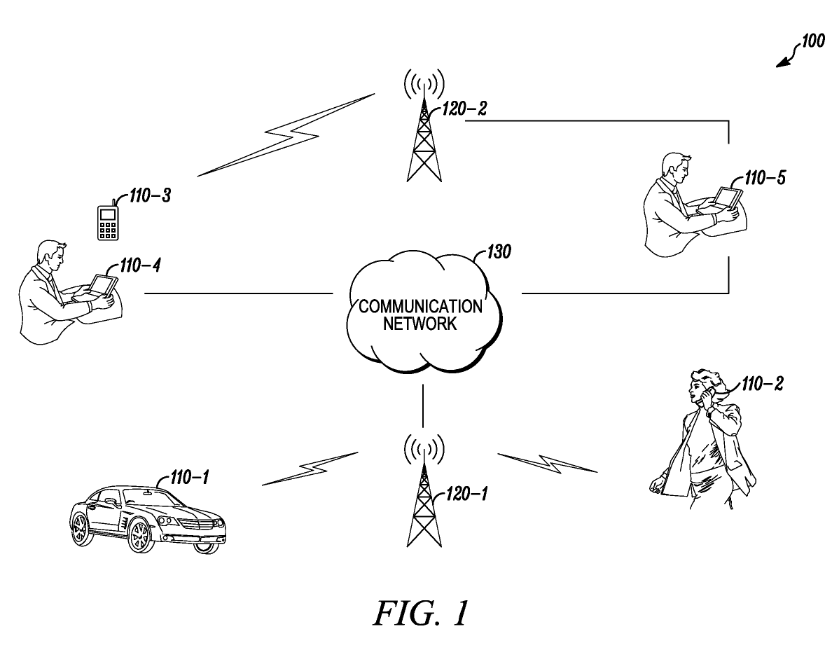

FIG. 1 illustrates a communication system in which methods and apparatus, consistent with the present invention, may be implemented. Specifically, FIG. 1 illustrates a wireless communication system 100 (also referred to as system 100 or communication system 100) including multiple communication devices 110-1 through 110-5. In one embodiment, the communication devices 110 are capable of wirelessly communicating with each other via one or more infrastructure devices 120-1 through 120-2. For example, a communication device 110-1 may wirelessly communicate with another communication device 110-2 via an infrastructure device 120-1. The infrastructure device 120 may be any wireless communication station installed at a fixed location of the wireless communication system 100. The infrastructure device 120 is sometimes referred to as a base station or radio base station or Node B (in 3G networks), or access point base station. In accordance with some embodiments, the communication devices 110 are capable of communicating with each other via a communication network 130. For example, the communication device 110-1 can communicate with communication devices 110-3 through 110-5 via communication network 130. In some instances, the communication devices 110 can be fixed or mobile and can communicate with each other over a wireless media with or without the support of infrastructure devices 120 or communication network 130. The communication network 130 may include one or more of private networks, public networks, such as the Internet, wireless networks, such as satellite and cellular networks, and local area wireless networks, such as WiFi or Bluetooth networks, local area networks (LANs), wide area networks (WANs), telephone networks, such as the Public Switched Telephone Networks (PSTN), or a combination of networks. Five communication devices and two infrastructure devices have been illustrated as connected to communication network 130 for simplicity. In practice, there may be more or less communication devices and infrastructure devices. Further, it is to be understood that the communication system 100 is only a general representation of communications among devices and, thus, may include multiple communication means and/or multiple communication networks. In fact, the communication system 100 may include multiple, distinct networks that have no connection with one another and/or no common communication means. It is also possible for the communication devices 110 to talk to each other directly without use of infrastructure or networks using a so called device-to-device ad hoc or mesh connection. In this mode of operation the communication devices may form a communication network among themselves without the need for the infrastructure devices by transmitting and receiving to each other directly. A hybrid system consisting of infrastructure devices coordinated with device-to-device ad hoc connection may also be employed.

The communication devices 110 may include devices, such as mobile phones, mainframes, minicomputers, desktop computers, laptops, notebook computers, personal digital assistants, or the like. For example, in FIG. 1, the communication device 110-2 is illustrated as a mobile device, which is often carried by its user, and thus, remains conveniently available. The communication devices 110 may transmit data over the communication network 130 or receive data from the communication network 130 via a wired, wireless, or optical connection.

In accordance with embodiments of the present invention, the wireless communication system 100 facilitates the communication devices 110 to sense the real time search requirements of the users and provide enhanced search results in the context of the real time needs of the user. In one embodiment, the communication devices 110 monitor data communication occurring at a user device, generate search results based on the monitored data, and provide search results to the user. In another example, the monitored data communication includes data transmitted to a remote communication device as well as data received from the remote communication device. In accordance with some embodiments, the monitored data comprises data related at least one of a voice conversation between users of communication devices, or a voice message composed and/or generated and/or transferred between communication devices, or an instant message composed and/or generated and/or transferred between communication devices, or a short text message composed and/or generated and/or transferred between communication devices or an electronic mail composed and/or generated and/or transferred between communication devices, or an audio generated at a microphone of a communication device or the combination of the above.

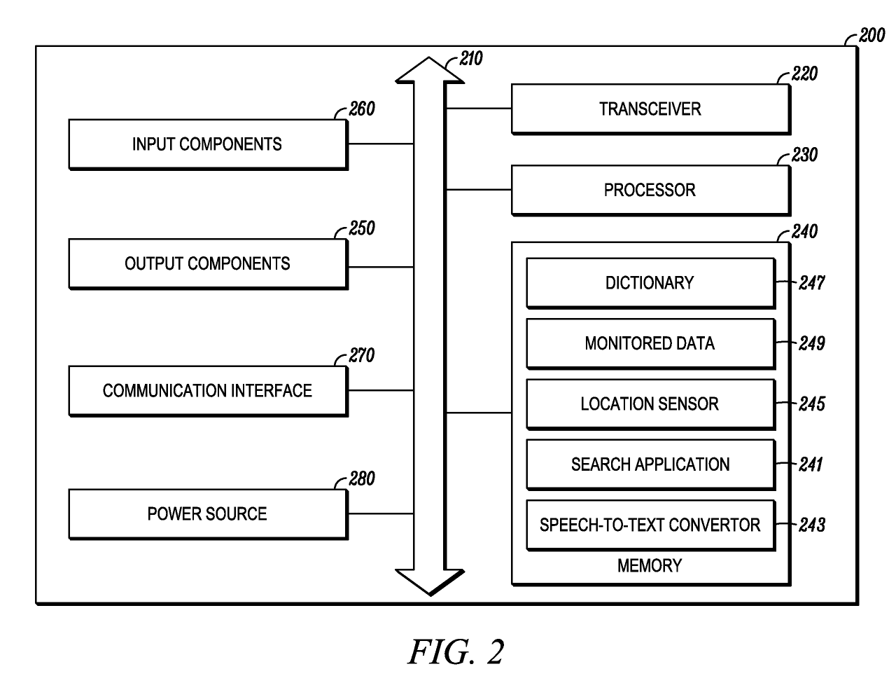

FIG. 2 illustrates a block diagram of an apparatus 200 employed in the communication system 100 of FIG. 1. The apparatus 200, for example, can be implemented in communication devices 110 shown in FIG. 1. The apparatus 200 includes a bus 210, one or more wired or wireless transceivers 220, a processor 230, a memory 240, one or more output components 250, one or more input components 260, a communication interface 270, and a power source 280. Each embodiment may include a user interface that comprises one or more output components 250 and one or more input components 260. The bus 210 may include one or more conventional buses that permit communication among the components of the apparatus 200. The processor 230 may include any type of conventional processor or microprocessor that interprets and executes instructions. Each transceiver 220 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11 (a, b, g or n); and other forms of wireless communication such as infrared technology. Each transceiver 220 may be a receiver, a transmitter or both.

The input components 260 of the apparatus 200 may include an audio input component such as a microphone, and a mechanical input component such as button or key selection sensors, touch pad sensor, touch screen sensor, capacitive sensor, motion sensor, and switch. Likewise, the output components 250 of the internal components of the apparatus 200 may include a variety of video, audio and/or mechanical outputs. Other examples of output components 250 include an audio output component such as a speaker, alarm and/or buzzer, and/or a mechanical output component such as vibrating or motion-based mechanisms.

The memory 240 of the apparatus 200 may be used by the processor 230 to store and retrieve data. The data that may be stored by the memory 240 include, but is not limited to, operating systems, applications, and data. Each operating system includes executable code that controls basic functions of the communication, such as interaction among the components of the internal components of the apparatus 200, communication with external devices via each transceiver 220 and/or the component interface (see below), and storage and retrieval of applications and data to and from the memory 240. Each application includes executable code utilizes an operating system to provide more specific functionality for the communication device. For example, according to one embodiment, as shown in FIG. 2, the memory includes application such as search application 241, speech-to-text converter 243, and location sensor 245. Data is non-executable code or information that may be referenced and/or manipulated by an operating system or application for performing functions of the communication device. For example, the memory 240 includes a dictionary 247, and monitored data 249. In one embodiment, the memory 240 stores raw data of monitored data 249. The raw data may be later processed and converted to any form of data that may allow the processor 230 to generate search results in accordance with some embodiments of the present invention. In one embodiment, the memory 240 stores text of monitored data 249. The dictionary 247 is a database including a list of predefined keywords. As used herein, the term “predefined keywords” shall be understood to refer to a list of keywords either preconfigured by the manufacturer of the communication device and/or keywords manually added to the dictionary 247 by the user and/or keywords added by the processor when there is a matching text between a detected user input and the monitored data 249. In accordance with some embodiments of the present invention, the processor 230 compares the monitored data 249 with the predefined keywords and determines one or more contextual data to provide search results in the context of the monitored data.

The search application 241 is responsible for processing information received from the processor based on the monitored data and/or a further search query entered by a user of the communication device 110, and generating search results in accordance with the embodiments of the present invention. In one embodiment, the search application 241 may be integrated in a web browser that provides a user interface to the World-Wide Web (“the Web), a valuable resource for information relating to virtually any subject, including business, education, entertainment, and travel, to name just a few.

The speech-to-text converter 243 is responsible for converting at least a portion of the monitored data 249 to text to enable the processor to compare the converted text with the list of predefined keywords. The location sensor 245 is responsible for determining real time geographical location of the communication device 110 that can enable the processor 230 to generate location specific search results. In one embodiment, the location sensor 245 may use global positioning system for determining geographical location of the communication device 110.

The processor 230 may generate commands based on information received from one or more input components 260 or by processing the received information in combination with other data, such as the information stored in the memory 240. For example, the transceiver 220 may monitor data transmitted to a remote communication device, and buffer the monitored data in the memory 240. The processor 230 may process the data buffered in the memory according to one or more predetermined rules, and may apply the processed data to the search application 241 to generate search results according to embodiments of the present invention. In one embodiment, the processor 230 is configured to identify the monitored data 249 buffered in the memory 240 for a given time period, for example, the processor may identify the last 30 seconds of monitored data buffered in the memory 240 and process the 30 seconds of monitored data to generate search results in accordance with some embodiments of the present invention. Further, the processor 230 may be configured to identify older data buffered in the memory 240 and delete the older data for the purpose of freeing-up memory 240. In one example, the processor 230 may use a marker to identify the beginning of the buffer and allow newer data to overwrite older data in the memory 240.

The communication interface 270 may use transceiver 220 to enable the communication device 110 to communicate with other devices and/or systems. For example, the communication interface 270 may include mechanisms for communicating with another device or system via a network, such as communication network 130. The apparatus 200 also includes a power source 280, such as a power supply or portable battery, for providing power to the other internal components of the apparatus.

It is to be understood that FIG. 2 is provided for illustrative purposes only and for illustrating components of a communication device 110 in accordance with the present invention, and is not intended to be a complete schematic diagram of the various components required for a communication device 110. Therefore, a communication device 110 may include various other components not shown in FIG. 2, or may include a combination of two or more components or a division of a particular component into two or more separate components, and still be within the scope of the present invention.

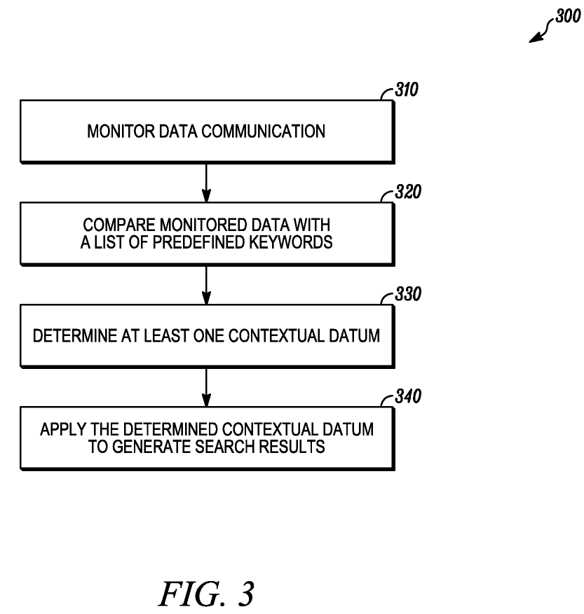

FIG. 3 illustrates a first method 300 of providing enhanced search results to a user of a communication device 110 in accordance with some embodiments. At block 310, the communication device 110 monitors data communication on a communication device associated with a user. In one embodiment, the communication device may initiate monitoring data in response to detecting at least one of an activation of the search application, or a user input in a user interface of the communication device or an environmental action such as state of motion of the communication device. Next, at block 320, as and when the data is generated and/or transmitted to the remote communication device, the communication device 110 compares the monitored data 249 with the list of predefined keywords of the dictionary 247. The communication device 110 proceeds to block 330 to determine at least one contextual datum from at least a portion of the monitored data based on a predetermined rule. For example, according to one predetermined rule, the communication device 110 determines the at least contextual datum based on whether the at least contextual datum corresponds to at least one of the predefined keywords. Next, at block 340, the communication device 110 generates a search result by applying the determined contextual datum to a search application 241.

In accordance with some embodiments, the communication device 110 activates the search application 241 in response to determining the at least one contextual datum. In one embodiment, when the communication device 110 detects a user input in the search application 241, the communication device compares the text associated with the user input with text associated with the monitored data 249, and adds at least one text associated with the user input that matches with at least one text associated with the monitored data to the list of the predefined keywords. In this manner, the dictionary 247 can be updated to include new keywords in the context of the monitored data 249.

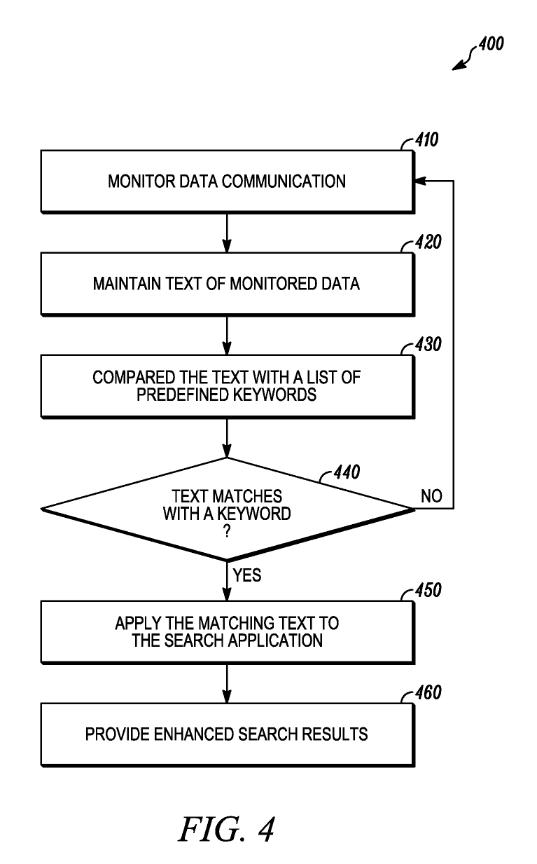

FIG. 4 illustrates a second method 400 of providing enhanced search results to a user of a communication device in accordance with some embodiments. At block 410, the communication device 110 monitors data communication occurring at the communication device 110. In accordance with some embodiments, the data communication includes data transferred between the communication device 110 and one other communication device. Next, at block 420, the communication device 110 maintains text of monitored data 249. In one embodiment, the communication device 110 converts a portion of monitored data, for example, data associated with a predetermined time period e.g. past thirty seconds, to text, and buffers the text of monitored data 249 in the memory 240. Next, at block 430, the communication device 110 compares the text of monitored data 249 with the list of predefined keywords. In one example, block 430 can compare the monitored data with text that corresponds with at least one of the predefined keywords and may include synonyms, colloquial expressions or other terms that have similar meaning to the predefined keywords. Next, at block 440, the communication device determines if at least one text associated with the monitored data 249 matches with at least one of the predefined keywords. If the communication device 110 finds a match between the text of monitored data 249 and the predefined keywords, then the communication device 110 automatically activates a search application and proceeds to block 450 to apply the at least one text that matches with at least one of the predefined keywords to the search application 241 and generates search results. Next, at block 460, the communication device 110 provides enhanced search results to the user. For example, the generated search results are displayed on the communication device 110.

Returning to block 440, when the communication device 110 determines that there is no matching or corresponding text between the text of the monitored data and the predefined keywords, the communication device 110 continues to monitor data communication occurring at the communication device 110 to identify opportunity of providing enhanced search results in consistent with the embodiments of the present invention.

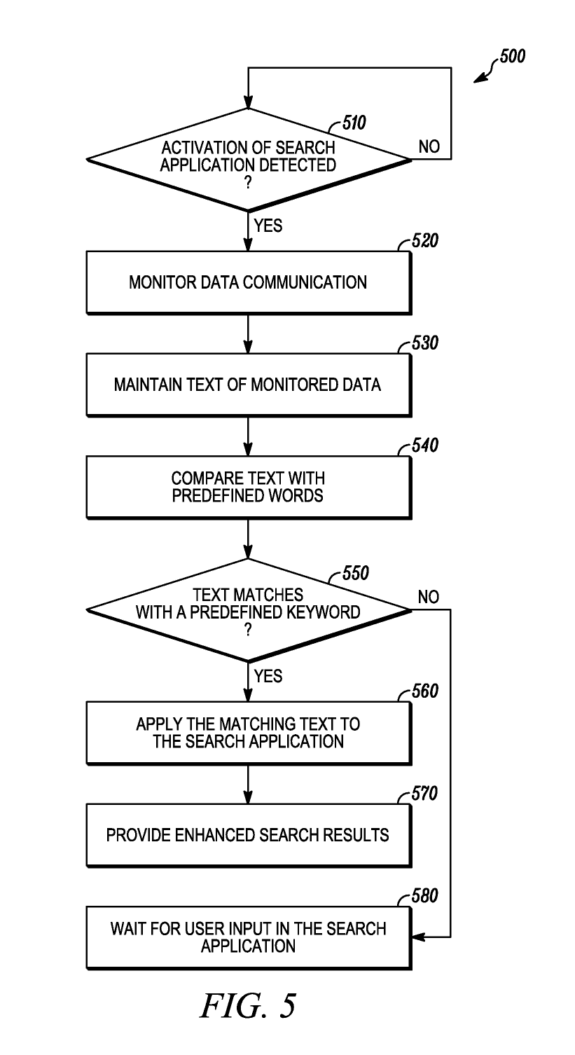

FIG. 5 illustrates a third method 500 of providing enhanced search results to a user of a communication device in accordance with some embodiments. At block 510, the communication device determines if a search application 241 has been activated. In accordance with some embodiments, the communication device 110 detects if a user has launched a web browser containing the search application. If the communication device 110 detects an activation of a search application, the communication device 110 proceeds to block 520 to monitor data communication occurring at communication device 110. In accordance with some embodiments, the data communication includes data transferred between the communication device 110 and one other communication device. Next, at block 530, the communication device 110 maintains text of monitored data 249. In one embodiment, the communication device 110 converts a portion of monitored data 249, for example, data associated with a predetermined time period e.g. past 60 seconds, to text, and buffers the text of monitored data 249 in the memory 240. Next, at block 540, the communication device 110 compares the text of monitored data with the list of predefined keywords. Next, at block 550, the communication device 110 determines if at least one text associated with the monitored data 249 corresponds or matches with at least one of the predefined keywords. If the communication device 110 finds a match between the text of monitored data 249 and the predefined keywords, then the communication device 110 proceeds to block 560 to apply the at least one text that corresponds or matches with at least one of the predefined keywords to a search application 241 and generates search results. Next, at block 570, the communication device 110 provides enhanced search results to the user.

Returning to block 550, when the communication device 110 determines that there is no corresponding or matching text between the text of the monitored data 249 and the predefined keywords, the communication device 110 waits for user input at block 580 to allow the user to enter any search query in the search application 241 for providing search results to the user using the search query entered by the user.

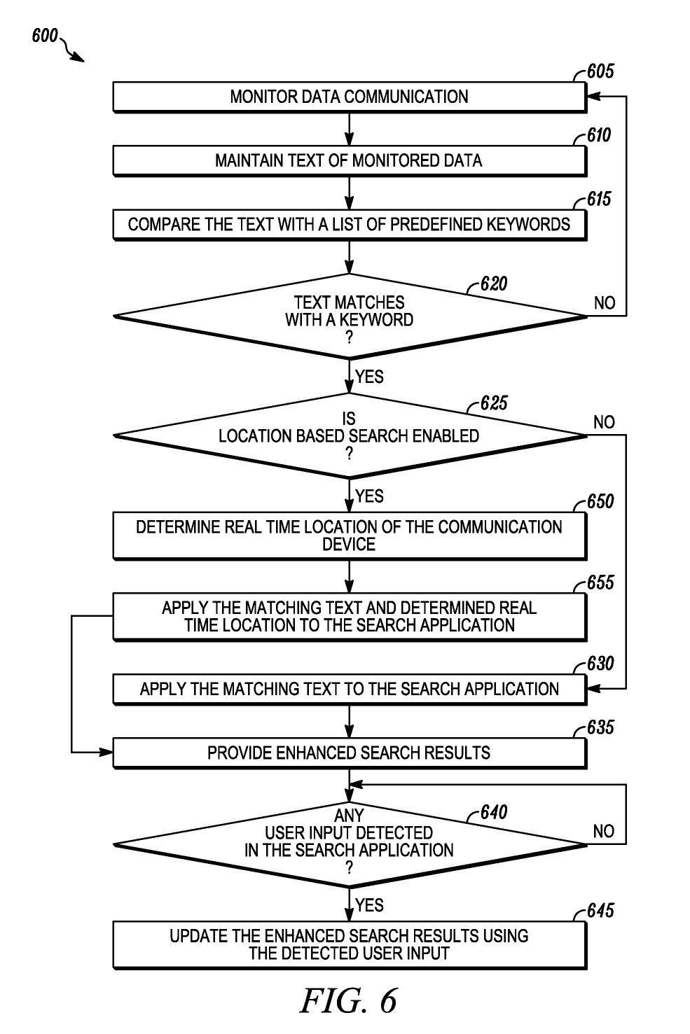

FIG. 6 illustrates a fourth method 600 of providing enhanced search results to a user of a communication device 110 in accordance with some embodiments. At block 605, the communication device 110 monitors data communication occurring at the communication device 110. In accordance with some embodiments, the data communication includes data transferred between the communication device and one other communication device. In accordance with some embodiments, the data communication includes at least one of a voice conversation between users of communication devices, or a voice message transferred between two communication devices, or an instant message transferred between communication devices, or an electronic mail transferred between communication devices, or the combination of the above. Next, at block 610, the communication device 110 maintains text of monitored data 249. In one embodiment, the communication device 110 converts a portion of monitored data 249, for example, data associated with a predetermined time period e.g. a time period of past thirty seconds, to text, and buffers the text of monitored data 249 in the memory 240.

Next, at block 615, the communication device 110 compares the text of monitored data 249 with the list of predefined keywords. Next, at block 620, the communication device 110 determines if at least one text associated with the monitored data 249 matches with at least one of the predefined keywords. If the communication device 110 does not find a match between the text of monitored data 249 and the list of predefined keywords, then the communication device 110 returns to block 605 to continue to monitor data communication occurring at the communication device to identify opportunity of providing enhanced search results in consistent with the embodiments of the present invention.

Returning to block 620, if the communication device 110 finds a match between the text of monitored data 249 and the list of predefined keywords, then the communication device 110 proceeds to block 625 to determine if a location based search is enabled. If the communication device 110 determines that the location based search is not enabled, then the communication device 110 activates a search application 241 and proceeds to block 630 to apply the at least one text that matches with at least one of the predefined keywords to the search application 241 and generates search results. Next, at block 635, the communication device 110 provides enhanced search results to the user. After the communication device 110 provides enhanced search results to the user, the communication device 110 waits for a predefined period of time to allow the user to input any search query to the search application 241. At block 640, the communication device 110 determines whether it has detected any user input in the search application 241. If the communication device 110 does not detect any user input in the search application 241, then the communication device 110 continues to wait for user input till the predefined period of time expires. On the other hand, when the communication device 110 detects any user input in the search application 241 during the predefined period of time, then the communication device 110 updates the enhanced search results using the detected user input as shown in block 645. For example, if the communication device 110 detects a search query in the form of user text input in the search application 241, then the communication device 110 applies the at least one text of the monitored data 249 that matches with at least one of the predefined keywords to the detected user text input to provide an updated search result to the user.

Returning to block 625, if the communication device 110 determines that the user has enabled the location based search, then the communication device 110 enables the location sensor 245 to determine the real time geographic location of the communication device 110 as shown in block 650. Next, at block 655, the communication device 110 activates a search application 241 and applies the at least one text that matches with at least one of the predefined keywords and the determined real time location to the search application 241 and generates search results in the context of the matching text and geographic location of the communication device 110. Then, at block 635, the communication device 110 provides location specific enhanced search results to the user. The communication device 110 then proceeds to block 640 to wait for a predefined period of time to allow the user to input any search query to the search application so as to update the location specific enhanced search result in the context of detected search query.

The following section provides scenarios or examples of providing enhanced search results based on monitored data communication which can be achieved according to one or more embodiments described above.

### EXAMPLE 1

Assume that a user named Bob is talking on a mobile phone to his friend Betty about going to a restaurant for dinner, and specifically Bob tells Betty that he doesn't want Italian food. At this point, Bob's mobile phone which is already monitoring the conversation between Bob and Betty, according to the some embodiments of the present invention, identifies that a portion of the conversation “doesn't want Italian” corresponds with one or more predefined keywords in the dictionary, e.g., “doesn't want Italian” or “not Italian”, and similarly Bob's mobile phone identifies that in the same conversation, the term “restaurant” is predefined in the dictionary. Subsequently, Bob's mobile phone activates a search application and applies a search criteria “doesn't want Italian” or “not Italian” and “restaurant” to the search application and generates search results associated with restaurants which are not related to Italian. It is important to note that Bob's mobile phone has not received any manual user input from Bob for initiating a search. Rather, Bob's mobile phone itself has identified the real time search requirement of Bob and subsequently provided search results for Bob in the context of his most recent conversation with Betty.

Suppose if Bob had enabled a location based search, then Bob's mobile phone would apply the search criteria “doesn't want Italian” or “not Italian” and “restaurant” including Bob's geographical location to the search application so as to provide search results in the context of Bob's geographical location. For example, if it is determined that Bob's current location is W. Taylor St., Chicago, Ill. 60607, Bob's mobile phone would generate a search result related to non-Italian restaurants in the vicinity of W.Taylor St. Bob can then input his own search query that can be used to filter the search results if necessary. If Betty's location is known, then Betty's location could also be used as an input to the search.

### EXAMPLE 2

Assume that Bob is traveling in a bus and is talking on a mobile phone to his friend Betty about gardening and lawn care and Bob is subsequently searching for “irrigation systems.” At this point, Bob's mobile phone, consistent with some embodiments of the present invention, records one or both sides of the conversation between Bob and Betty for a period of time, say 30 seconds, and generates search results to Bob such that residential lawn irrigation system services are ranked ahead of agricultural services and systems for irrigating farm fields.

### EXAMPLE 3

In another scenario, assume that Bob is working in his home using his desktop computer and launches a web browser containing a search application. At this point, Bob's desktop computer detects that a search application has been activated and immediately begins to monitor any data communication occurring at Bob's computer. Consider that the following conversation (in italics) is taking place between Bob and Betty.
Bob: Hi Betty
Betty: Hello, Bob
Bob: Are you interested in dinner tonight?
Betty: Sure, could we get Italian?
Bon: Absolutely! Let me check what's available.
   At this point, Bob's computer detects the word “check” which is also predefined in the list of keywords of dictionary. Bob's computer, consistent with some embodiments of the present invention, applies a search query “Italian” “Dinner” “tonight” including the current geographical location of Bob and Betty to the search application and generates a search result related to one or more Italian restaurants near Bob's and Betty's locations with a reservation available tonight.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of a wireless communication system for providing enhanced search results to a user, comprising:
monitoring data communication on a user device;
determining at least one contextual datum from at least a portion of the monitored data based on a predetermined rule; and
generating a search result by applying the determined contextual datum to a search application.

2. The method of claim 1, wherein determining at least one contextual datum from the monitored data based on a predetermined rule comprises:
comparing the monitored data with a list of predefined keywords; and
determining that the at least one contextual datum corresponds to at least one of the predefined keywords.

3. The method of claim 1, further comprising activating the search application in response to determining the at least one contextual datum.

4. The method of claim 2, further comprising:
detecting a user input in the search application;
comparing text associated with the user input with text associated with the monitored data; and
adding at least one text associated with the user input that matches with at least one text associated with the monitored data to the list of predefined keywords.

5. A method of operating a communication device for providing enhanced search results to a user, comprising:
monitoring data communication occurring at the communication device;
comparing text associated with the monitored data communication with a list of predefined keywords; and
applying at least one text that corresponds to at least one of the predefined keywords to a search application to provide enhanced search results to the user.

6. The method of claim 5, wherein monitoring the data communication comprises monitoring at least one of a voice conversation, or a voice message, or an instant message, or a short text message, or an electronic mail being communicated between the communication device and at least one other communication device.

7. The method of claim 6, wherein monitoring at least one of a voice conversation further comprises:
recording the voice conversation; and
converting at least a portion of the voice conversation to text.

8. The method of claim 5, further comprising maintaining text of at least a portion of monitored data communication for a predefined time period.

9. The method of claim 5, wherein monitoring data communication occurring at the communication device comprises monitoring data communication in response to detecting at least one of an activation of the search application, or a user input in a user interface of the communication device or an environmental action.

10. The method of claim 5, further comprising:
detecting a user text input in the search application; and
applying the at least one text to the detected user text input in the search application to provide an updated enhanced search results.

11. The method of claim 5, further comprising automatically activating the search application upon determining that the at least one text matches with the at least one of the predefined keywords.

12. The method of claim 5, further comprising:
determining real time location of the user of the communication device; and
applying the at least one text to the determined real time location to provide a location specific enhanced search results to the user.

13. The method of claim 5, wherein applying at least one text that corresponds to at least one of the predefined keywords comprises applying at least one text that is at least one of synonymous or colloquial to at least one of the predefined keywords.

14. An apparatus for providing enhanced search results to a user of a communication device, comprising:
a transceiver configured to monitor data communication occurring at the communication device;
a memory configured to store text associated with the monitored data communication, and a list of predefined keywords; and
a processor operatively coupled to the transceiver and the memory, wherein the processor is configured to compare the text associated with the monitored data communication with the list of predefined keywords, and apply at least one text that matches with at least one of the predefined keywords to a search application to provide enhanced search results to the user.

15. The apparatus of claim 14, further comprising a speech-to-text converter for converting at least some of speech associated with the monitored data communication to text.

16. The apparatus of claim 14, further comprising a location sensor for determining real time location of the communication device to enable the processor to update the search results in the context of the determined real time location of the communication device.

17. The apparatus of claim 14, wherein the transceiver is further configured to monitor at least one of a voice conversation, or a voice message, or an instant message, or a short text message, or an electronic mail being communicated between the communication device and at least one other communication device.

18. The apparatus of claim 14, wherein the transceiver is further configured to monitor data communication upon detecting at least one of an activation of the search application, or a user input in a user interface of the communication device or an environmental action.

19. The apparatus of claim 14, wherein the processor is further configured to detect a user text input in the search application, and apply the at least one text to the detected user input in the search application to provide an updated enhanced search results in the context of the user text input to the user.

20. The apparatus of claim 14, wherein the processor is further configured to automatically activate the search application upon determining that the least one text matches with the at least one of the predefined keywords.
